(19) United States
(12) Patent Application Publication
(10) Pub. No.: US 2020/0180057 A1
(43) Pub. Date: Jun. 11, 2020

(54) APPARATUS FOR ELECTROCHEMICAL MACHINING GEAR OUTLINE AND ALIGNMENT STRUCTURE THEREOF

(71) Applicant: METAL INDUSTRIES RESEARCH & DEVELOPMENT CENTRE, KAOHSIUNG CITY (TW)

(72) Inventors: YOU-LUN CHEN, KAOHSIUNG CITY (TW); DA-YU LIN, KAOHSIUNG CITY (TW); ZHI-WEN FAN, KAOHSIUNG CITY (TW); HUNG-YI CHEN, KAOHSIUNG CITY (TW); CHEN-HUI CHANG, KAOHSIUNG CITY (TW); CHIN-HUNG WEN, KAOHSIUNG CITY (TW); CHUN-WEI CHEN, KAOHSIUNG CITY (TW)

(21) Appl. No.: 16/210,312

(22) Filed: Dec. 5, 2018

(51) Int. Cl. B23H 3/02; B23H 3/06; B23H 7/26; B23P 15/14

(52) U.S. Cl. CPC B23H 3/02; B23P 15/14; B23H 7/26; B23H 3/06

(57) ABSTRACT

An apparatus for electrochemical machining gear outline and the alignment structure thereof is disclosed, the apparatus comprises first and second alignment members. The first and second alignment members include a plurality of first alignment teeth and second alignment teeth, respectively. Recessing a gear-outline edge of the first alignment teeth by a distance and extending a gear-outline edge of the second alignment teeth by the distance for against to each other to align the first and second alignment members. A cathode electrode includes a plurality of machining teeth with both gear-outline edges recessed by the distance for against the gear-outline edge of the second alignment teeth with the extended distance to align machining teeth. Thereby, before trimming the gear-outline of a workpiece, the machining gap between the machining teeth and the teeth of the workpiece can be aligned first.

### FIELD OF THE INVENTION

The present invention relates generally to a machining apparatus, and particularly to an apparatus for electrochemical machining and trimming the gear outline of the gears in a workpiece using electrochemical machining and to the alignment structure thereof.

### BACKGROUND OF THE INVENTION

Gears are the most important component in mechanical transmission mechanisms. Thanks to their advantages of high transmission efficiency, accurate transmission ratio, and wide applications, gears are applied extensively in automobiles, aerospace, ships, instruments, and meters. As the requirements in the hardness, strength, wear resistance, and lifetime of gears in mechanical transmission designs become increasingly stringent, hardened gears are adopted generally.

Trimming of gears is normally arranged after thermal treatment. After thermal treatment, the hardness of gears will increase. If trimming of gears is performed by the cutting method according to the prior art, due to the large cutting force and high cutting temperature, cutting tools will wear seriously and gears will deform on the surface. Thereby, it is not appropriate to trim high-hardness gears using the cutting method according to the prior art. If a computer numerical control (CNC) machine tool is used to trim high-hardness gears, the machining cost will increase. In addition, there will be hard-to-remove flashes and burrs on the surface of the gears.

### SUMMARY

An objective of the present invention is to provide an apparatus for electrochemical machining gear outline and the alignment structure thereof. The apparatus for electrochemical machining gear outline adopts electrochemical machining to machine the gear outline of the gears in a workpiece. In addition, before trimming the gear outline of the gears in a workpiece, the alignment structure aligns the machining gap between the machining teeth of the cathode electrode and the teeth of the workpiece for performing electrochemical machining.

The present invention discloses an apparatus for electrochemical machining gear outline and the alignment structure thereof, which comprise a base, a first moving mechanism, a first alignment member, a second alignment member, a second moving mechanism, and a cathode electrode. The first moving mechanism is disposed on the base. The first alignment member is connected with the first moving mechanism and includes a plurality of first alignment teeth. Each of the first alignment teeth includes a first gear-outline edge and a second gear-outline edge. The first gear-outline edge is recessed by a distance. The second alignment member includes a plurality of second alignment teeth. Each of the second alignment teeth includes a third gear-outline edge and a fourth gear-outline edge. The third gear-outline edge extends by a distance and is against the first gear-outline edge of the first alignment teeth. The second moving mechanism is disposed on the base. The cathode electrode is disposed at the second moving mechanism and includes a plurality of machining teeth. Each of the machining teeth includes a fifth gear-outline edge and a sixth gear-outline edge. The fifth gear-outline edge and the sixth gear-outline edge are both recessed by a distance. The fifth gear-outline edge is against the third gear-outline edge of the second alignment teeth.

### BRIEF DESCRIPTION OF THE DRAWINGS

FIG. 1 shows a stereoscopic diagram of the electrochemical machining apparatus according to an embodiment of the present invention;

FIG. 2A to FIG. 2C show a cross-sectional view, an enlarged view of the cross-sectional view, and an exploded view of a partial structure of the apparatus for electrochemical machining gear outline according to an embodiment of the present invention;

FIG. 3A and FIG. 3B show a top view of the first alignment member and a partially enlarged view of FIG. 3A according to the present invention;

FIG. 4A and FIG. 4B show a top view of the second alignment member and a partially enlarged view of FIG. 4A according to the present invention;

FIG. 5A and FIG. 5B show a top view of the cathode electrode and a partially enlarged view of FIG. 5A according to the present invention;

FIG. 6A and FIG. 6B show a top view of the second alignment member against the first alignment member and a partially enlarged view of FIG. 6A according to the present invention;

FIG. 7A and FIG. 7B show a top view of the cathode electrode against the second alignment member and a partially enlarged view of FIG. 7A according to the present invention;

FIG. 8A and FIG. 8B show a top view of the third alignment member and a partially enlarged view of FIG. 8A according to the present invention;

FIG. 9A to FIG. 9C show a bottom view of the second alignment member connected with the third alignment member and the partially enlarged view and the stereoscopic diagram of FIG. 9A according to the present invention;

FIG. 10 shows a stereoscopic diagram of the workpiece according to an embodiment of the present invention;

FIG. 11 shows a schematic diagram of the first alignment member of the apparatus for electrochemical machining gear outline moving and projecting the conductive electrode according to an embodiment of the present invention;

FIG. 12 shows a schematic diagram of the apparatus for electrochemical machining gear outline aligning the first alignment member and the cathode electrode;

FIG. 13 shows a schematic diagram of the apparatus for electrochemical machining gear outline pressing the workpiece according to the present invention;

FIG. 14 shows a schematic diagram of moving the cathode electrode to enter the workpiece for trimming the tooth outline of the gear of the workpiece using the apparatus for electrochemical machining gear outline according to the present invention; and

FIG. 15A and FIG. 15B show a top view of the gear when the cathode electrode corresponds to the workpiece and a partially enlarged view of FIG. 15A according to the present invention.

### DETAILED DESCRIPTION

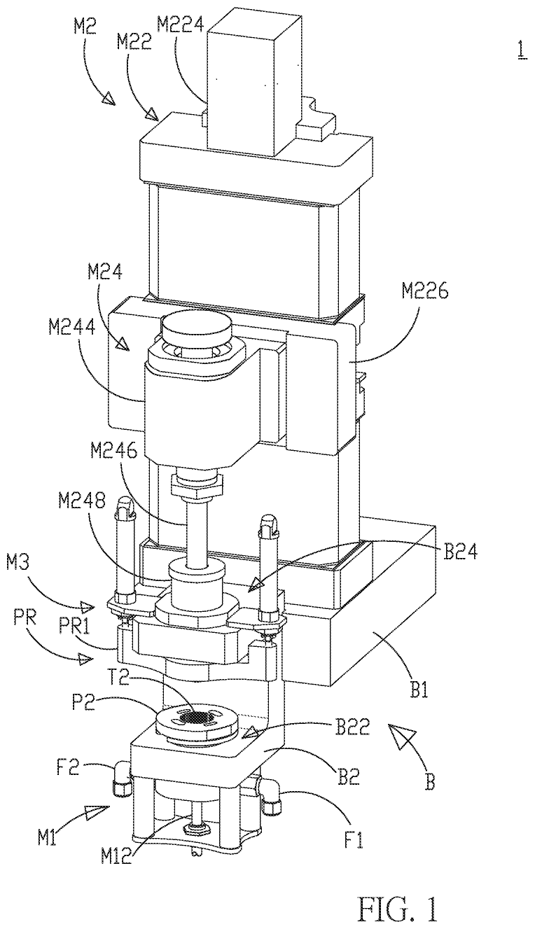

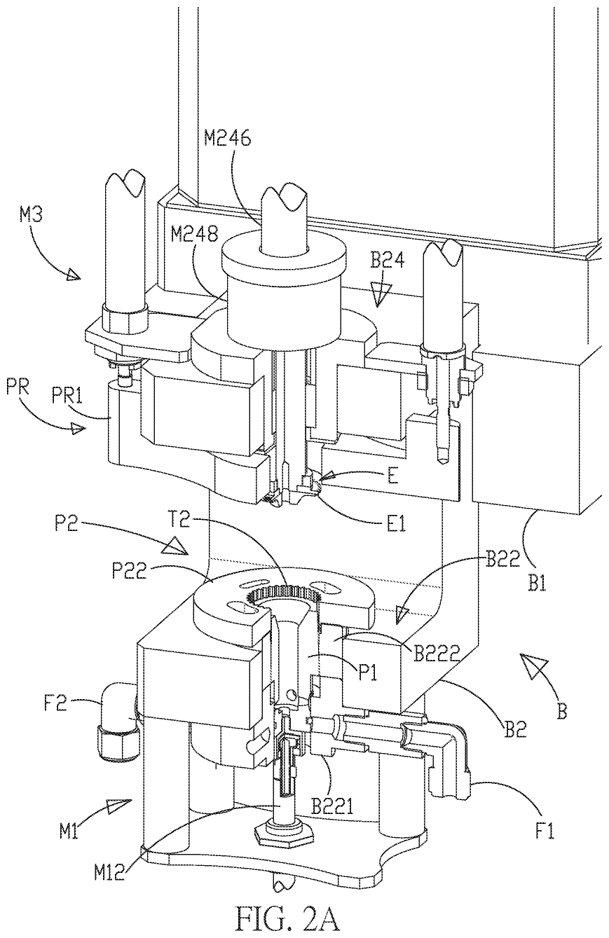

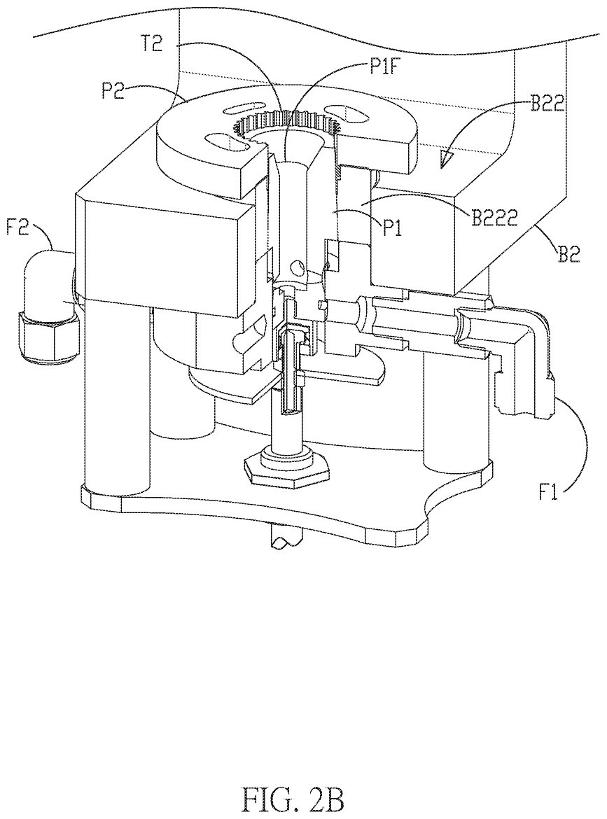

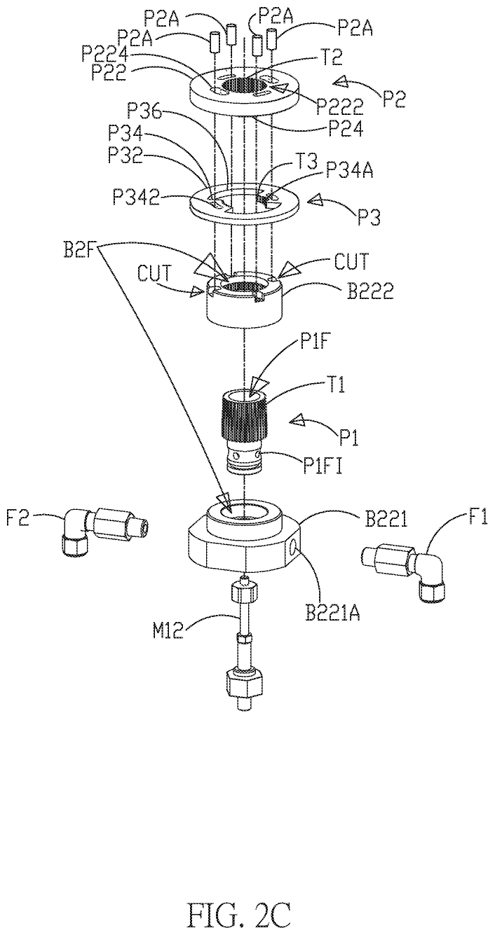

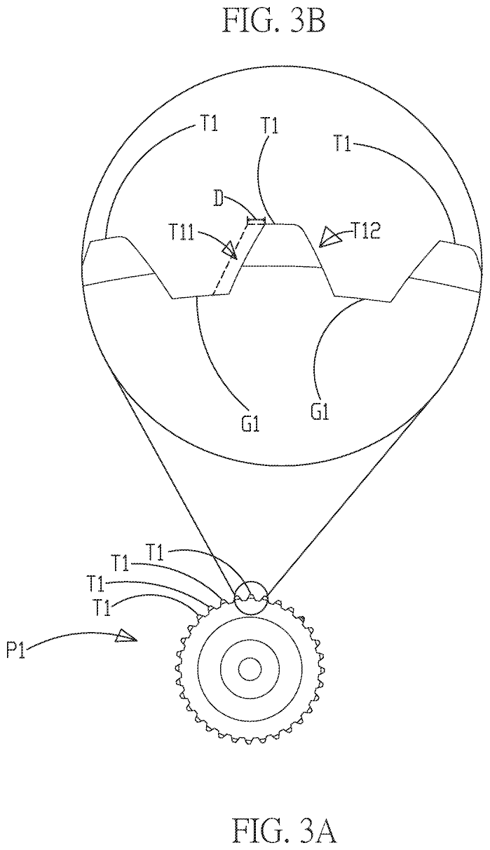

Please refer to FIGS. 1 to 2C. The present invention provides an apparatus for electrochemical machining gear outline 1, which is used for trimming the inner gear outline of a workpiece. The apparatus for electrochemical machining gear outline 1 comprises a base B, a first moving mechanism M1, a first alignment member P1, a second alignment member P2, a second moving mechanism M2, and a cathode electrode E. The first and second alignment members P1, P2 are used for aligning the machining gap between the machining teeth of the cathode electrode E and the teeth of the workpiece before the cathode electrode E trims the inner gear outline of the workpiece for performing electrochemical machining.

The base B includes a body B1 and a carrier B2. The carrier B2 is disposed on the front side of the body B1. The body B1 and the carrier B2 are formed integrally. The carrier B2 includes a first platform B22 and a second platform B24. The second platform B24 is located above the first platform B22 with a gap therebetween. The first moving mechanism M1 is disposed on the carrier B2. The second moving mechanism M2 is disposed on the body B1. The cathode electrode E is disposed at the second moving mechanism M2.

The first alignment P1 is disposed on the first carrier B22 and includes a plurality of first alignment teeth T1. Each of the first alignment teeth T1 includes a first gear-outline edge T11 and a second gear-outline edge T12. The first gear-outline edge T11 is recessed by a distance D. There is a first gear groove G1 between two adjacent first alignment teeth T1. The first gear-outline edge T11 is recessed toward the second gear-outline edge by the distance D. The first moving mechanism M2 can include a moving member M12 located at and connected to the bottom of the first alignment member P1 for driving the first alignment member P1 to perform linear movement.

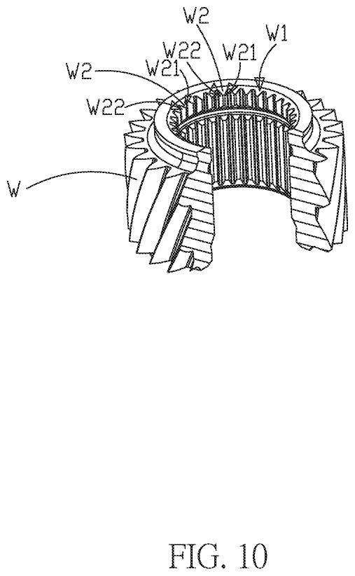

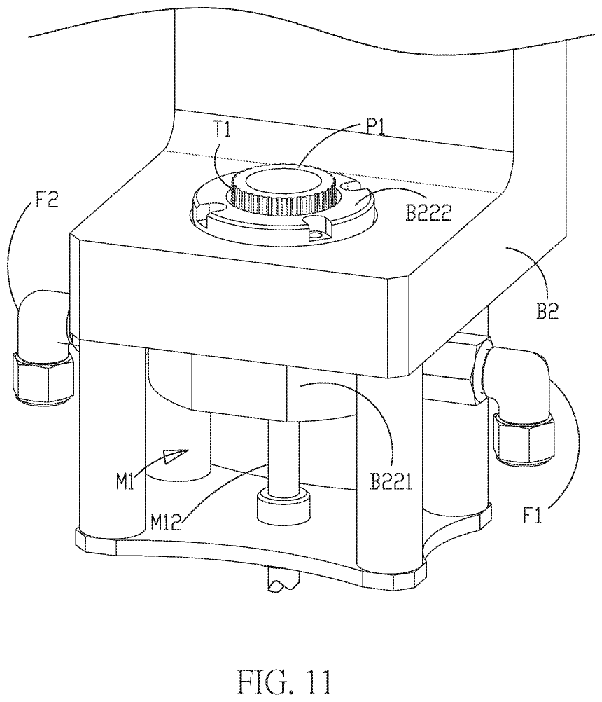

Before the workpiece W (as shown in FIG. 10) is placed to the apparatus for electrochemical machining gear outline 1 and trims the inner gear outline, a second gear-outline W22 of a plurality of inner teeth W2 of the teeth W1 of the workpiece W is against the second gear-outline edge T12 of the plurality of first alignment teeth T1 of the first alignment member P1 for aligning the teeth W1 of the workpiece W. According to the present embodiment, the workpiece W is equivalent to the inner gear, while the first alignment member P1 is equivalent to the outer gear.

According to the above description, the second gear-outline edge T12 of the first alignment member P1 is identical to the second gear-outline edge W22 of the workpiece W. Thereby, while designing the plurality of first alignment teeth T1 of the first alignment member P1, the plurality of inner teeth W2 of the workpiece W should act as a reference tooth. A first gear-outline edge W21 and the second gear-outline edge W22 are the first reference gear-outline edge and the second reference gear-outline edge, respectively. Thereby, the first gear-outline edge T11 opposing to the first gear-outline edge W21 of the inner tooth (the reference tooth) is recessed by the distance D.

In addition, as shown in FIGS. 1 to 2C, the second moving mechanism M2 can include a linear moving mechanism M22 and a spin mechanism M24. The linear moving mechanism M22 is disposed at the body B1. The spin mechanism M24 is disposed at the linear moving mechanism M22. The linear moving mechanism M22 can include a linear driving device M224 and a linear moving member M226. The linear driving device M224 can be a linear motor. The linear driving device M224 drives the linear moving member 226 to perform linear motion.

The spin mechanism M24 includes a spin driving device M244. The spin driving device M244 is connected with the cathode electrode E for rotating the cathode electrode E. The spin driving device M244 can be a spin motor. Moreover, the spin mechanism M24 can further include a connecting rod M246, which is connected with the spin driving device M244 and passes through an alignment sleeve M248 for connecting to the cathode electrode E. The alignment sleeve M248 is disposed on the second platform B24 for aligning the connecting rod M246.

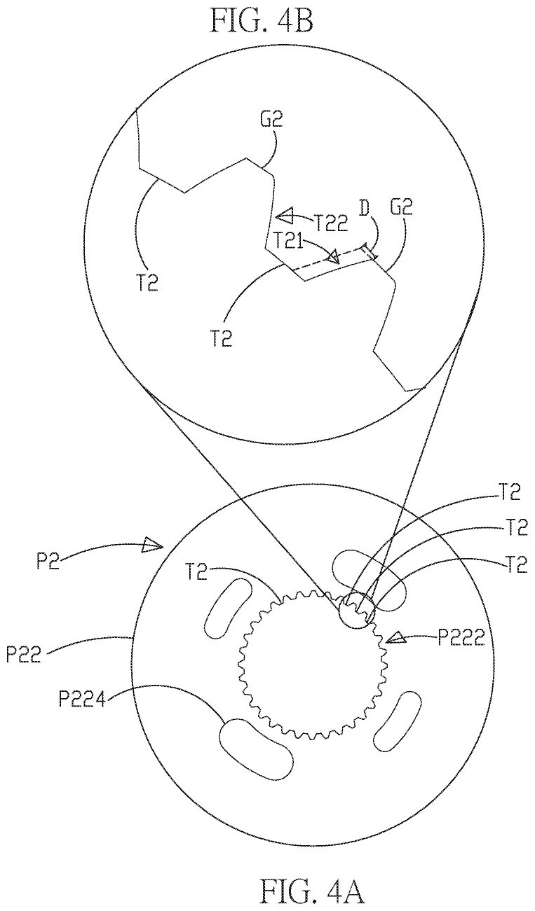

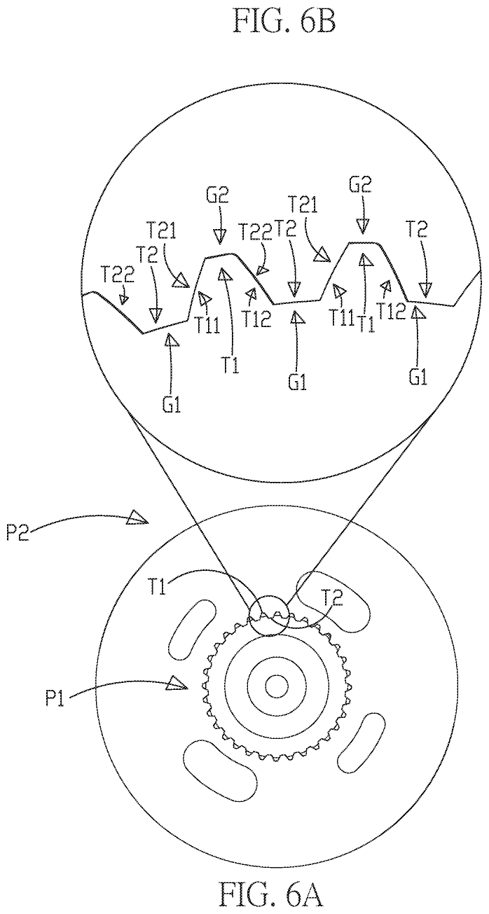

The second alignment member P2 and the first alignment member P1 are coaxial and disposed on the first carrier B22. The first alignment member P1 is movable and thus enabling the plurality of first alignment teeth T1 to be in the second alignment member P2. As shown in FIGS. 4A and 4B, the second alignment member P2 includes an annular member P2 with a plurality of second alignment teeth T2 around an inner circumference P222. Each of the second alignment teeth T2 includes a third gear-outline edge T21 and a fourth gear-outline edge T22. The third gear-outline edge T21 opposing to the first gear-outline edge W21 is extended by the distance D of A second gear groove G2 is located between two adjacent second alignment teeth T2. The third gear-outline edge T21 is extended to the opposing fourth gear-outline edge T22 by the distance D. The fourth gear-outline T22 might not extend. The second alignment member P2 is equivalent to an inner gear. While disposing the second alignment member P2 on the first carrier B22, the second alignment member P2 is rotated for making the plurality of third gear-outline edge T21 lean against the first gear-outline T11 of the plurality of first alignment teeth T1, as shown in FIGS. 6A and 6B, for fixing the second alignment member P2.

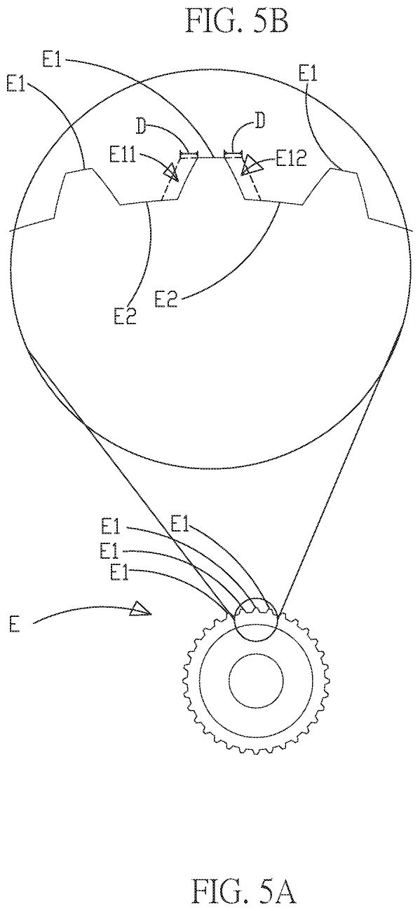

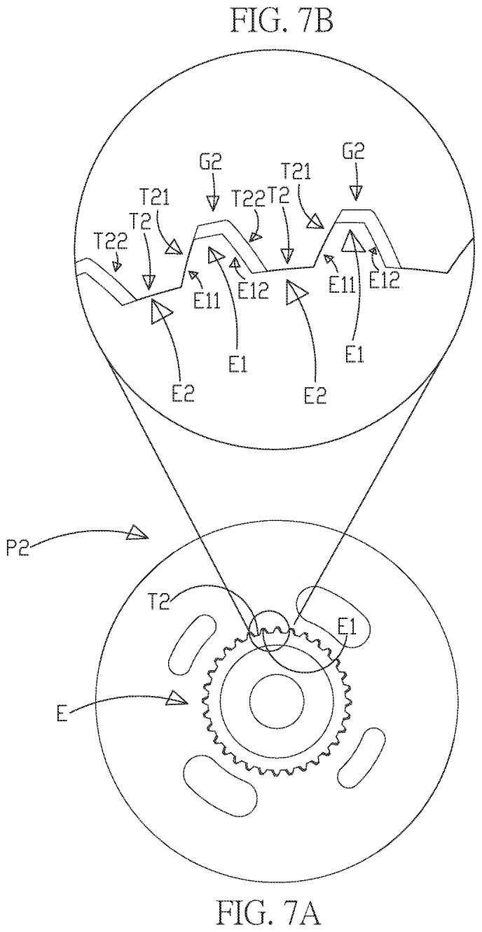

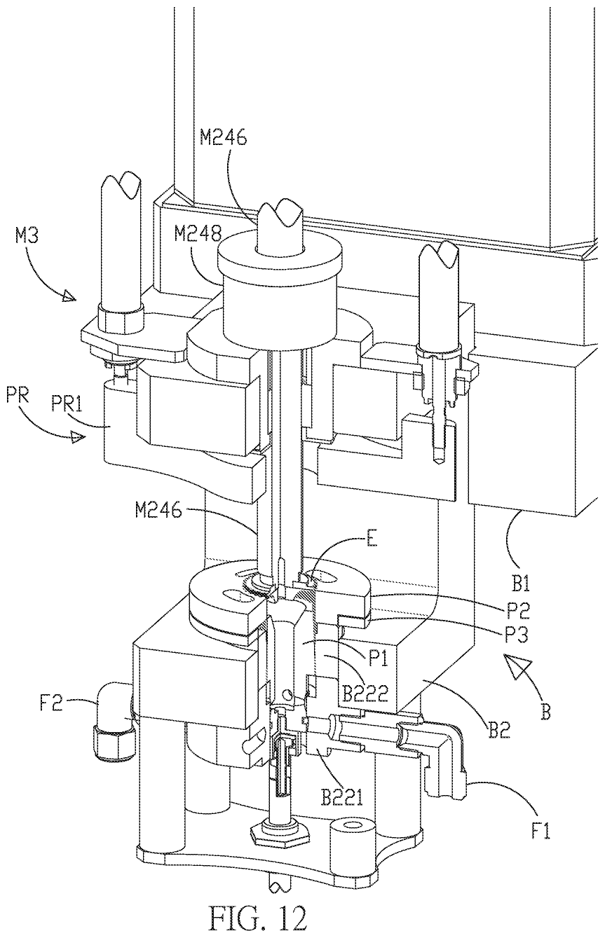

As shown in FIG. 1 to FIG. 2B and FIGS. 5A and 5B, the cathode electrode E includes a plurality of machining teeth E1. Each of the machining teeth E1 includes a fifth gear-outline edge E1 and a sixth gear-outline edge E12 opposing to the first gear-outline edge W21 and the second gear-outline edge W22, respectively, are recessed by the distance D. A machining teeth groove E2 is located between two adjacent machining teeth E1. The fifth gear-outline edge E11 is recessed by the distance D toward the sixth gear-outline edge E12; the sixth gear-outline edge E12 is recessed by the distance D toward the fifth gear-outline edge E11. The cathode electrode E is movable and located in the second alignment member P2. At this moment, the cathode electrode E can be rotated for making the plurality of fifth gear-outline edges E11 lean against the plurality of third gear-outline edges T21, as shown in FIGS. 7A, 7B, and 12. Besides, the spin mechanism M24 is driven not to rotate for forcing the cathode electrode E not to rotate and hence aligning the plurality of machining teeth E1. The cathode electrode E is also equivalent to the outer gear.

As shown in FIGS. 2B, 2C, 6A, and 6B, the first alignment member P1 is located in the second alignment member P2. In addition, the plurality of first alignment teeth T1 and the plurality of first teeth grooves G1 are interlaced with the plurality of second alignment teeth T2 and the plurality of second teeth grooves G2. Each third gear-outline edge T21 is against one first gear-outline edges T11, respectively. Each fourth gear-outline edge T22 correspond to one second gear-outline edge T12, respectively.

An alignment sleeve B221 and a conductive electrode B222 are both disposed on the first carrier B22. The alignment sleeve B221 passes through the first platform B22 from the bottom of the first platform B22. The bottom of the alignment sleeve B221 is disposed against the bottom of the first platform B22. The conductive electrode B222 is annular. The bottom of the conductive electrode B222 is disposed against the top of the alignment sleeve B221. The first alignment member P1 is accommodated on the conductive electrode B222 and the alignment sleeve B221. The second alignment member P2 is disposed on the conductive electrode B222.

As shown in FIGS. 2B, 2C, 7A, and 7B, the cathode electrode E is movable and located in the second alignment member P2 for allocating the plurality of machining teeth E1 to the plurality of teeth grooves G2, respectively. Namely, the plurality of second alignment teeth T2 are located in the plurality of machining teeth grooves E2, respectively. Thereby, by rotating the cathode electrode E, each fifth gear-outline edge E11 of the cathode electrode E can lean against one third gear-outline edge T21 of the second alignment member P2, while each sixth gear-outline edge E12 of the cathode electrode E can correspond to one fourth gear-outline edge T22 of the second alignment member P2.

According to the above description, before performing electrochemical machining on the workpiece W, the second alignment member P2 can be disposed on the carrier B2 and the plurality of third gear-outline edges T21 of the second alignment member P2 are made to lean against the plurality of first gear-outline edges T11 of the first alignment member P1, respectively. Thereby, the third gear-outline edges T21 of the second alignment member P2 can be aligned according to the first gear-outline edges T11 of the first alignment member P1. In addition, the plurality of fifth gear-outline edges E11 of the machining electrode E are made to lean against the plurality of third gear-outline edges T21 of the second alignment member P2, respectively. Thereby, the fifth gear-outline edges E11 of the machining electrode E can be aligned according to the third gear-outline edges T21 of the second alignment member P2. It means that the location of the fifth gear-outline edge E11 of the machining electrode E is identical to the location the first gear-outline edge T11 of the first alignment member P1. After completing aligning the relative positions of the plurality of machining teeth E1 and the plurality of first alignment teeth T1, the second alignment member P2 can be disassembled and the workpiece is placed instead for trimming the workpiece W using the machining electrode E.

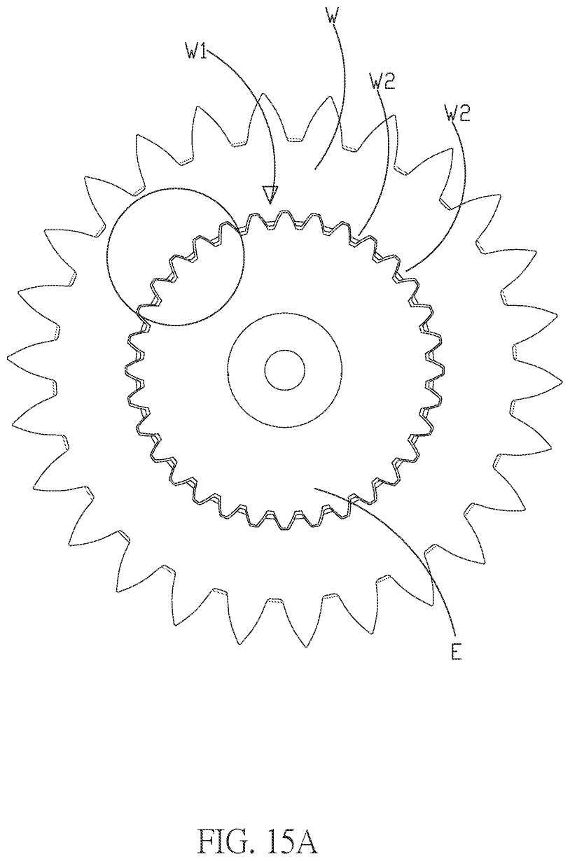

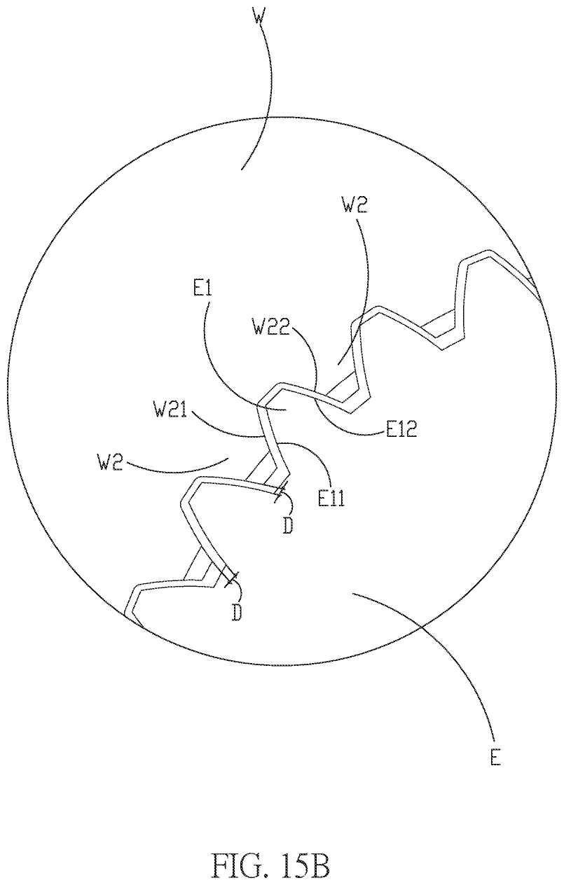

Because the plurality of first gear-outline edges T11 of the first alignment member P1 and the fifth gear-outlines E11 of the machining teeth E5 are recessed by the distance D, when the workpiece W is placed in the apparatus for electrochemical machining gear outline 1 and the plurality of second gear-outline edges W22 of the workpiece W are against the plurality of second gear-outline edges T12 of the first alignment member P1, the distance D exists between the plurality of fifth gear-outline edges E11 and the plurality of first gear-outline edges W21, respectively, as shown in FIG. 15A and FIG. 15B. Besides, because the sixth gear-outline edges E12 of the machining teeth E1 are also recessed by the distance D, the distance D exists between the plurality of sixth gear-outline edges E12 and the second gear-outline edges W22 of the workpiece W, respectively, as shown in FIG. 15A and FIG. 15B. The distance D is just the machining gap between the plurality of machining teeth E1 and the workpiece W. The alignment structure according to the present invention comprises the first alignment member P1 and the second alignment member P2, used for aligning the above machining gap before trimming the workpiece W.

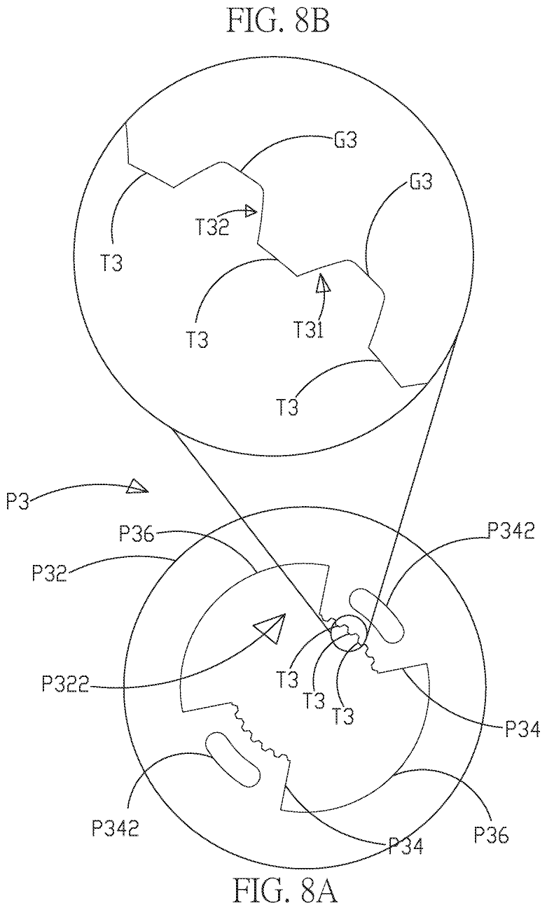

As shown in FIG. 2C, FIG. 8A, and FIG. 8B, in addition to the first alignment member P1 and the second alignment member P2, the alignment structure according to the present invention can further comprise a third alignment member P3 located between the second alignment member P2 and the first alignment member P1 and including a plurality of third alignment teeth T3. Each of the third alignment teeth T3 includes a seventh gear-outline edge T31 and an eighth gear-outline edge T32. A third teeth groove G3 is located between two adjacent third alignment teeth T3. The plurality of third alignment teeth T3 are inner teeth. While disposing the third alignment member P3 to the conductive electrode B22, rotate the third alignment member P3 for making the plurality of eighth gear-outline edges T32 lean against the plurality of second gear-outline edges T12 and fixing the third alignment member P2 to the conductive electrode B222. Both of the seventh gear-outline edges T31 and the eighth gear-outline edges of the third alignment member P3 are not recessed for emulating the alignment of the workpiece W and the first alignment member P1.

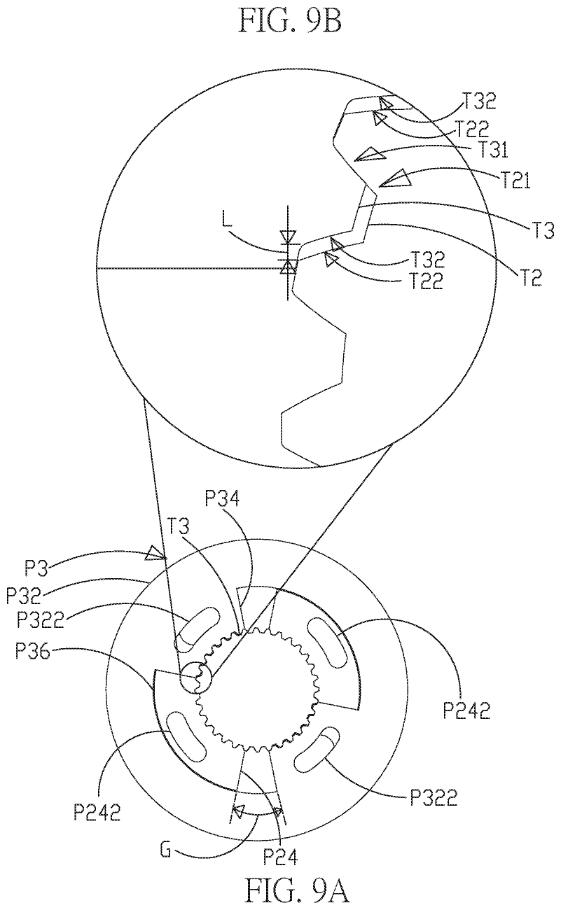

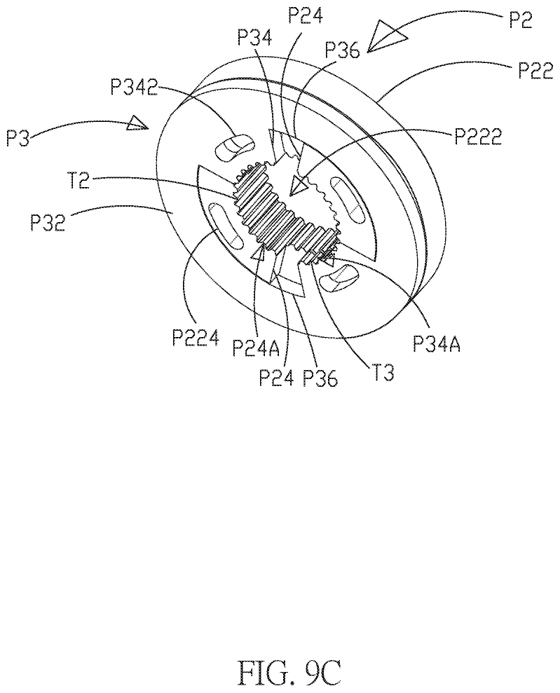

The third alignment member P3 includes an annular member P32, two extension parts P34, and two accommodation parts P36. The two extension parts P34 extend from an inner circumference P322 of the annular member P32 to the center of circle and opposing to each other. Namely, the two extension parts P34 extend toward the center of the annular member P32. The plurality of third alignment teeth T3 are formed on a radial surface P34A of the two extension parts P34, as shown in FIG. 9C. Besides, the two accommodation parts P36 are located between the annular member P36 and the two extension parts P34 and opposing to each other. The third alignment member P3 is equivalent to an inner gear

As shown in FIGS. 9A to 9C, the second alignment member P2 can further include two projective parts P24 located on an outer side surface of the annular member P22 of the second alignment member P2 and opposing to each other. In addition, the two projective parts P24 are accommodated in the two accommodation parts P36 and adjacent to the two extension parts P32. A portion of the plurality of second alignment teeth T2 extends from the inner circumference P222 of the second alignment member P2 to a radial surface P24A of the two projective parts P24. A gap G is located between the extension part P34 of the third alignment member P3 and the projective part P24 of the second alignment member P2 for allowing rotation of the second alignment member P2. Besides, A gap L is located between the seventh gear-outline edge T31 and the third gear-outline edge T21. The gap L is equivalent to the distance D.

As shown in FIG. 2B and FIG. 2C, the first alignment member P1 includes a first channel P1F and a plurality of electrolyte inlets P1FI. The first channel P1F is located at the central region of the first alignment member P1. The plurality of electrolyte inlets P1FI are located at the bottom of the first alignment member P1 and communicate with the first channel P1F. A second channel B2F is located at the central region of the alignment sleeve B221 and the conductive electrode B222. A plurality of electrolyte inlets B221A are located at the bottom of the alignment sleeve B221 and communicate with the second channel B2F. The plurality of electrolyte inlets B221A are connected with a first transport connector F1 and a second transport connector F2, respectively. The first alignment member P1 is accommodated in the second channel B2F. Thereby, the plurality of electrolyte inlets P1FI and the first channel P1F communicate with the second channel B2F.

As shown in FIG. 2B and FIG. 2C, the alignment structure can further include a plurality of fixing members P2A passing through a plurality of second fixing holes P224 on the annular member P22, a plurality of fixing holes P342 of the extension parts P34, and the accommodation parts P36 and fixed to a plurality of notches CUT on the conductive electrodes B222.

As shown in FIG. 10 and FIG. 11, the plurality of first alignment teeth T1 correspond to the plurality of inner teeth W2 of the workpiece W. Thereby, when the workpiece W is placed on the conductive electrode B222, the workpiece W can be put around the first alignment member P1 for fixing the workpiece W. In addition, the plurality of inner teeth W2 can gear into the plurality of first alignment teeth T1. By rotating the workpiece W, the second gear-outline edges W2 can lean against the second gear-outline edges T12 of the plurality of alignment members P1 for aligning the plurality of inner teeth W.

As shown in FIG. 11, the first alignment member P1 extends outside the conductive electrode B22. Thereby, the plurality of first alignment teeth T1 of the first alignment member P1 are higher than the conductive electrode B222, so that the workpiece W can be placed on the conductive electrode B222 and put around the first alignment member P1. In addition, before the workpiece W is placed on the conductive electrode B222, the third alignment member P3 is disposed on the conductive electrode B222 and the eighth gear-outline edges T32 of the third alignment teeth T3 are made to lean against the second gear-outline edges T12 of the plurality of first alignment teeth T1. Afterwards, the second alignment member P2 is disposed on the third alignment member P3. The third gear-outline edges T21 of the plurality of second alignment teeth T2 are made to lean against the first gear-outline edges T11 of the plurality of first alignment teeth T1. Next, as shown in FIG. 12, the cathode electrode E is moved and the fifth gear-outline edges E11 of the plurality of machining teeth E1 are made to lean against the third gear-outline edges T21 of the plurality of second alignment teeth T2. Thereby, the machining gape between the cathode electrode E and the plurality of inner teeth W2 is aligned.

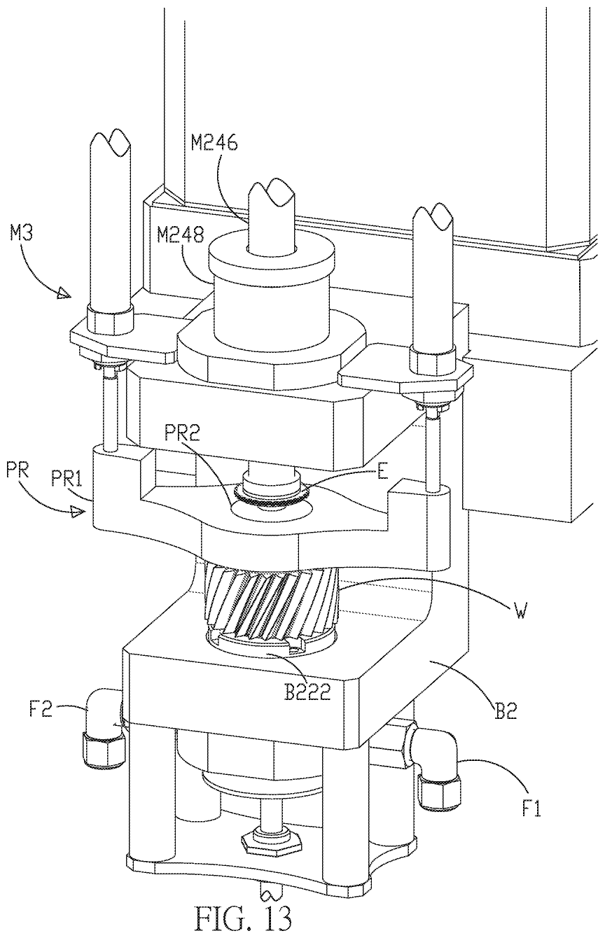

As shown in FIG. 1 and FIG. 13, a press mechanism PR is disposed on the carrier B2 and opposing to the first alignment member P1. The press mechanism PR includes a third moving mechanism M3 and a press member PR1. The third moving mechanism M3 is disposed on the carrier B2; the press member PR1 is connected with the third moving mechanism M3 and opposing to the first alignment member P1 for driving the press member PR1 to press the workpiece W and hence fixing the workpiece W. The press member PR1 includes an opening PR2 corresponding to the workpiece W and the cathode electrode E. In addition, the first moving mechanism M1 drives the first alignment member P1 to move downwards for enabling the first alignment member P1 to exit the inside of the workpiece W.

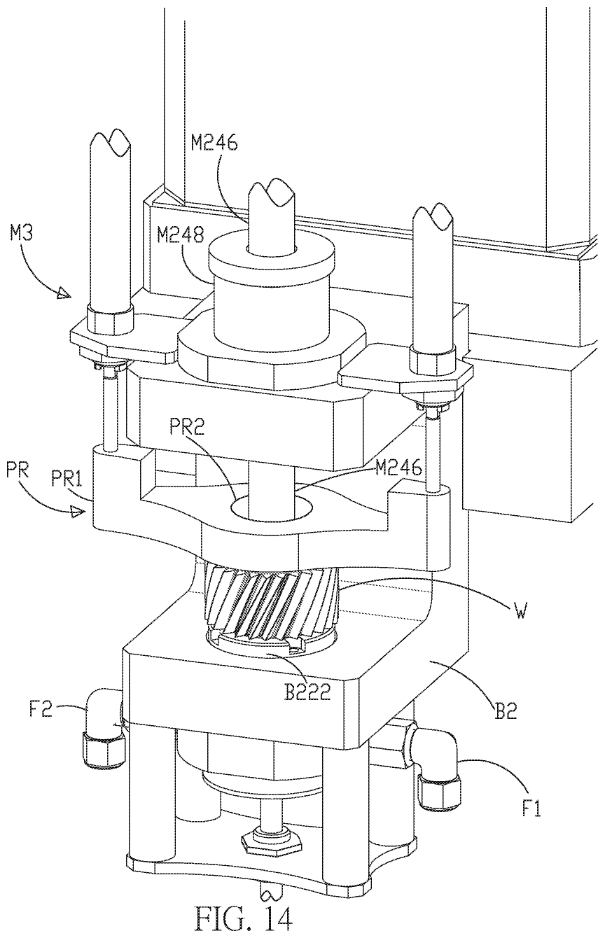

As shown in FIG. 14, the cathode electrode E moves downward and passes through the opining PR2 to the inside of the workpiece and corresponding to the plurality of inner teeth W2 for trimming the outline of the plurality of inner teeth W2.

As shown in FIG. 2B, the electrolyte can pass along the first channel P1F. And then in the central region of the first alignment member P1, the electrolyte is injected to the plurality of inner teeth W2 of the workpiece W. Besides, the cathode electrode E is coupled to the cathode of the power supply (not shown in the FIG.); the conductive electrode B22 is coupled to the anode of the power supply (not shown in the FIG.). It means that the workpiece W is coupled to the anode of the power supply. Thereby, the cathode electrode E can perform electrochemical machining on the plurality of inner teeth W2 of the workpiece W for trimming the outline of the plurality of inner teeth W2.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An apparatus for electrochemical machining gear outline, comprising:
a base,
a first moving mechanism, disposed on said base;
a first alignment member, connected with said first moving mechanism, including a plurality of first alignment teeth, each said first alignment tooth including a first gear-outline edge and a second gear-outline edge, and said first gear-outline edge recessed by a distance;
a second alignment member, including a plurality of second alignment teeth, each said second alignment tooth including a third gear-outline edge and a fourth gear-outline edge, and said third gear-outline edge extended by said distance and leaning against said first gear-outline edge of said plurality alignment teeth;
a second moving mechanism, disposed on said base; and
a cathode electrode, disposed on said second moving mechanism, including a plurality of machining teeth, each said machining tooth including a fifth gear-outline edge and a sixth gear-outline edge, said fifth gear-outline edge and said sixth gear-outline edge recessed by said distance, and said fifth gear-outline edge leaning against said third gear-outline edge of said plurality of second alignment teeth.

2. The apparatus for electrochemical machining gear outline of claim 1, wherein said first gear-outline edge and said fifth gear-outline edge opposing a first reference gear-outline edge of a reference tooth are recessed by said distance; said third gear-outline edge opposing to said first reference gear-outline edge of said reference tooth is extended by said distance; and said sixth gear-outline edge opposing to a second reference gear-outline edge of said reference tooth is recessed by said distance.

3. The apparatus for electrochemical machining gear outline of claim 1, further comprising a third alignment member, located between said second alignment member and said first alignment member, including a plurality of third alignment teeth, each said third alignment tooth including a seventh gear-outline edge and an eighth gear-outline edge, and said eighth gear-outline edge leaning against said second gear-outline edge of said plurality of first alignment teeth of said first alignment member.

4. The apparatus for electrochemical machining gear outline of claim 3, wherein said third alignment member includes:
an annular member,
two extension parts, extending inward from an inner circumference of said annular member and opposing to each other, and said plurality of third teeth formed on a radial surface of said two extension parts; and
two accommodation parts, located between said annular member and said two extension parts and opposing to each other.

5. The apparatus for electrochemical machining gear outline of claim 4, wherein said second alignment member includes:
an annular member, said plurality of second alignment teeth formed on an inner circumference of said annular member of said second alignment member; and
two projective parts, located on an outer side surface of said annular member of said second alignment member and opposing to each other, accommodated in said two accommodation parts of said third alignment member and adjacent to said two extension parts, and a portion of said second alignment teeth extending from said inner circumference of said annular member of said second alignment member to a radial surface of said two projective parts.

6. The apparatus for electrochemical machining gear outline of claim 4, wherein said third alignment member is equivalent to an inner gear.

7. The apparatus for electrochemical machining gear outline of claim 1, further comprising a conductive electrode, annular shaped, disposed on said base, and said first alignment member accommodated on said conductive electrode.

8. The apparatus for electrochemical machining gear outline of claim 1, wherein said first alignment member includes a channel located in a central region of said first alignment member.

9. The apparatus for electrochemical machining gear outline of claim 1, further comprising a press mechanism, disposed on said base, opposing said first alignment member, including:
a third moving mechanism, disposed on said base; and
a press member, connected with said third moving mechanism, and opposing to the first alignment member.

10. The apparatus for electrochemical machining gear outline of claim 1, wherein said first alignment member and said cathode electrode are equivalent to the outer gear.

11. The apparatus for electrochemical machining gear outline of claim 1, wherein said second alignment member is equivalent to an inner gear.

12. An alignment structure of an apparatus for electrochemical machining gear outline, aligning a cathode electrode including a plurality of machining teeth, each said machining tooth including a fifth gear-outline edge and a sixth gear-outline edge, said fifth gear-outline edge and said sixth gear-outline edge recessed by a distance, comprising:
a first alignment
a first alignment member, including a plurality of first alignment teeth, each said first alignment tooth including a first gear-outline edge and a second gear-outline edge, and said first gear-outline edge recessed by said distance; and
a second alignment member, including a plurality of second alignment teeth, each said second alignment tooth including a third gear-outline edge and a fourth gear-outline edge, and said third gear-outline edge extended by said distance and leaning against said first gear-outline edge of said plurality alignment teeth;
where said fifth gear-outline edge of said plurality of machining teeth of said cathode electrode leans against said third gear-outline edge of said plurality of second alignment teeth.

13. The alignment structure of an apparatus for electrochemical machining gear outline of claim 12, further comprising a third alignment member, located between said second alignment member and said first alignment member, including a plurality of third alignment teeth, each said third alignment tooth including a seventh gear-outline edge and an eighth gear-outline edge, and said eighth gear-outline edge leaning against said second gear-outline edge of said plurality of first alignment teeth of said first alignment member.

14. The alignment structure of an apparatus for electrochemical machining gear outline of claim 13, wherein said third alignment member includes:
an annular member,
two extension parts, extending inward from an inner circumference of said annular member and opposing to each other, and said plurality of third teeth formed on a radial surface of said two extension parts; and
two accommodation parts, located between said annular member and said two extension parts and opposing to each other.

15. The alignment structure of an apparatus for electrochemical machining gear outline of claim 14, wherein said second alignment member includes:
an annular member, said plurality of second alignment teeth formed on an inner circumference of said annular member of said second alignment member; and
two projective parts, located on an outer side surface of said annular member of said second alignment member and opposing to each other, accommodated in said two accommodation parts of said third alignment member and adjacent to said two extension parts, and a portion of said second alignment teeth extending from said inner circumference of said annular member of said second alignment member to a radial surface of said two projective parts.

16. The alignment structure of an apparatus for electrochemical machining gear outline of claim 14, wherein said third alignment member is equivalent to an inner gear.

17. The alignment structure of an apparatus for electrochemical machining gear outline of claim 12, wherein said first alignment member and said cathode electrode are equivalent to the outer gear.

18. The alignment structure of an apparatus for electrochemical machining gear outline of claim 12, wherein said second alignment member is equivalent to an inner gear.
